(19) United States
(12) Patent Application Publication
(10) Pub. No.: US 2024/0112437 A1
(43) Pub. Date: Apr. 4, 2024

(54) ESTIMATION APPARATUS, MODEL GENERATION APPARATUS, AND ESTIMATION METHOD

(71) Applicant: NEC Corporation, Tokyo (JP)

(72) Inventor: Hiroo Ikeda, Tokyo (JP)

(73) Assignee: NEC Corporation, Tokyo (JP)

(21) Appl. No.: 18/200,338

(22) Filed: May 22, 2023

(30) Foreign Application Priority Data
Sep. 29, 2022 (JP) 2022-156128

(51) Int. Cl. G06V 10/25; G06V 10/22

(52) U.S. Cl. CPC G06V 10/25; G06V 10/22

(57) ABSTRACT

An estimation apparatus includes an acquisition unit and an estimation unit. The acquisition unit acquires an image. The estimation unit estimates the number of target objects included in a target region being at least part of the acquired image by using a learned model. Input data of the model are an image. Output data of the model include likelihood data and numerical data. The likelihood data indicate a likelihood of a one or more target objects being included in each of a plurality of partial regions acquired by dividing the image. The numerical data indicate an estimated number of target objects for a partial region estimated to include one or more target objects out of the plurality of partial regions. The estimation unit estimates the number of target objects included in a target region by using the likelihood data and the numerical data.

This application is based upon and claims the benefit of priority from Japanese patent application No. 2022-156128, filed on Sep. 29, 2022, the disclosure of which is incorporated herein in its entirety by reference.

### BACKGROUND

### Technical Field

The present invention relates to an estimation apparatus, a model generation apparatus, an estimation method, a model generation method, and a program.

### Related Art

There is a technology for estimating the number of objects in an image by using image analysis, a learned model, and the like.

“Objects as Points” by Xingyi Zhou, et al., Apr. 25, 2019, arXiv:1904.07850v2 (NPL 1) discloses a neural network with an image as an input. The neural network in NPL 1 outputs a map indicating the position of an object as a likelihood, a map indicating an amount of correction of the position of the object, and a map indicating the size of the object, each map being acquired by dividing the image into a plurality of regions.

### SUMMARY

However, the technology in the aforementioned NPL 1 can indicate information about only one object for one region by an output map. Therefore, there is an issue that the number of objects cannot be accurately estimated when a plurality of objects are positioned in one region such as when a plurality of objects exist close to each other in an image.

An example of an object of the present invention is, in view of the aforementioned issue, to provide an estimation apparatus, a model generation apparatus, an estimation method, a model generation method, and a program that enable high-precision estimation of the number of objects in an image even when a plurality of objects exist close to each other in the image.

According to an example aspect of the present invention, an estimation apparatus including:
an acquisition unit that acquires an image; and
an estimation unit that estimates a number of at least one target object included in a target region being at least part of the acquired image by using a learned model, wherein
input data of the model are the image,
output data of the model include:
   likelihood data indicating a likelihood of the one or more target objects being included in each of a plurality of partial regions acquired by dividing the image; and
   numerical data indicating an estimated number of the at least one target object for the partial region estimated to include the one or more target objects out of the plurality of partial regions, and
the estimation unit estimates a number of the at least one target object included in the target region by using the likelihood data and the numerical data is provided.

According to an example aspect of the present invention, a model generation apparatus including:
a training data acquisition unit that acquires training data in which a training image and ground truth data are associated with each other; and
a generation unit that generates a model by performing machine learning using the training data, wherein
input data of the model are an image, and
output data of the model include:
   likelihood data indicating a likelihood of one or more target objects being included in each of a plurality of partial regions acquired by dividing the image; and
   numerical data indicating an estimated number of the at least one target object for the partial region estimated to include the one or more target objects out of the plurality of partial regions is provided.

According to an example aspect of the present invention, an estimation method including, by one or more computers:
acquiring an image; and
estimating a number of at least one target object included in a target region being at least part of the acquired image by using a learned model, wherein
input data of the model are the image,
output data of the model include:
   likelihood data indicating a likelihood of the one or more target objects being included in each of a plurality of partial regions acquired by dividing the image; and
   numerical data indicating an estimated number of the at least one target object for the partial region estimated to include the one or more target objects out of the plurality of partial regions, and
estimation of a number of the at least one target object included in the target region is performed by using the likelihood data and the numerical data is provided.

According to an example aspect of the present invention, a model generation method including, by one or more computers:
acquiring training data in which a training image and ground truth data are associated with each other; and
generating a model by performing machine learning using the training data, wherein
input data of the model are an image, and
output data of the model include:
   likelihood data indicating a likelihood of one or more target objects being included in each of a plurality of partial regions acquired by dividing the image; and
   numerical data indicating an estimated number of the at least one target object for the partial region estimated to include the one or more target objects out of the plurality of partial regions is provided.

According to an example aspect of the present invention, a program causing a computer to function as an estimation apparatus, wherein
the estimation apparatus includes:
   an acquisition unit that acquires an image; and
   an estimation unit that estimates a number of at least one target object included in a target region being at least part of the acquired image by using a learned model,
input data of the model are the image,
output data of the model include:
   likelihood data indicating a likelihood of the one or more target objects being included in each of a plurality of partial regions acquired by dividing the image; and
   numerical data indicating an estimated number of the at least one target object for the partial region estimated to include the one or more target objects out of the plurality of partial regions, and
the estimation unit estimates a number of the at least one target object included in the target region by using the likelihood data and the numerical data is provided.

According to an example aspect of the present invention, a program causing a computer to function as a model generation apparatus, wherein
the model generation apparatus includes:
   a training data acquisition unit that acquires training data in which a training image and ground truth data are associated with each other; and
   a generation unit that generates a model by performing machine learning using the training data,
input data of the model are an image, and
output data of the model include:
   likelihood data indicating a likelihood of one or more target objects being included in each of a plurality of partial regions acquired by dividing the image; and
   numerical data indicating an estimated number of the at least one target object for the partial region estimated to include the one or more target objects out of the plurality of partial regions is provided.

According to the example aspects of the present invention, an estimation apparatus, a model generation apparatus, an estimation method, a model generation method, and a program that enable high-precision estimation of the number of objects in an image are acquired even when a plurality of objects exist close to each other in the image.

### BRIEF DESCRIPTION OF THE DRAWINGS

The above and other objects, advantages and features of the present invention will be more apparent from the following description of certain preferred example embodiments taken in conjunction with the accompanying drawings, in which:

FIG. 1 is a diagram illustrating an overview of an estimation apparatus according to a first example embodiment.

FIG. 2 is a diagram illustrating an input and output of an estimation model according to a comparative example.

FIG. 3 is a diagram illustrating contents of likelihood data, position data (x), position data (y), size data (w), and size data (h) according to the comparative example.

FIG. 4 is a diagram illustrating states of target objects related to the data illustrated in FIG. 3.

FIG. 5A and FIG. 5B are diagrams for illustrating an issue in the method according to the comparative example.

FIG. 6 is a diagram illustrating an input and an output of an estimation model according to the first example embodiment.

FIG. 7 is a diagram illustrating contents of likelihood data, position data (x), position data (y), size data (w), size data (h), and numerical data according to the first example embodiment.

FIG. 8 is a diagram illustrating states of target objects related to the data illustrated in FIG. 7.

FIG. 9 is a diagram illustrating a functional configuration of the estimation apparatus according to the first example embodiment.

FIG. 10 is a flowchart illustrating an overview of an estimation method executed by the estimation apparatus according to the first example embodiment.

FIG. 11 is a diagram illustrating a computer for providing the estimation apparatus.

FIG. 12 is a diagram illustrating an overview of a model generation apparatus according to the first example embodiment.

FIG. 13 is a block diagram illustrating a functional configuration of the model generation apparatus according to the first example embodiment.

FIG. 14 is a flowchart illustrating a flow of a model generation method executed by the model generation apparatus according to the first example embodiment.

FIG. 15 is a diagram illustrating data output by an estimation model in an estimation apparatus according to a second example embodiment.

FIG. 16 is a diagram illustrating states of target objects related to the data illustrated in FIG. 15.

FIG. 17 is a diagram for illustrating a processing example in an estimation unit according to a fourth example embodiment.

### DETAILED DESCRIPTION

The invention will be now described herein with reference to illustrative example embodiments. Those skilled in the art will recognize that many alternative example embodiments can be accomplished using the teachings of the present invention and that the invention is not limited to the example embodiments illustrated for explanatory purposes.

Example embodiments of the present invention will be described below by using drawings. Note that, in every drawing, similar components are given similar signs, and description thereof is omitted as appropriate.

“Acquisition” may be hereinafter based on a user input or a program instruction. Further, “acquisition” may be active acquisition or passive acquisition. The active acquisition refers to an apparatus getting data stored in another apparatus or a storage medium. Examples of the active acquisition include making a request or an inquiry to another apparatus and receiving a response, and readout by accessing another apparatus or a storage medium. The passive acquisition refers to inputting data output from an apparatus to another apparatus. Examples of the passive acquisition include reception of distributed (or, for example, transmitted or push notified) data, selective acquisition from received data or information, and generation of new data by data editing (such as conversion to text, data rearrangement, partial data extraction, or file format change) and acquisition of the new data.

### First Example Embodiment

### Estimation Apparatus

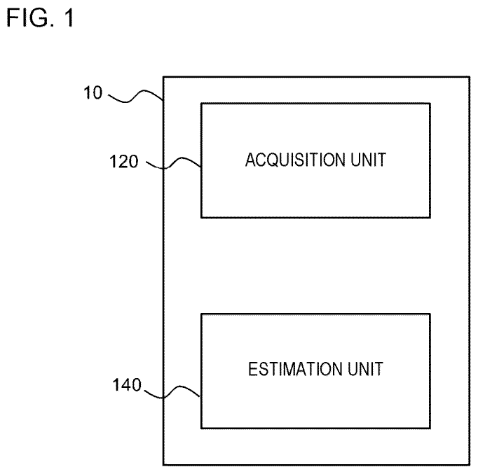

FIG. 1 is a diagram illustrating an overview of an estimation apparatus 10 according to a first example embodiment. The estimation apparatus 10 includes an acquisition unit 120 and an estimation unit 140. The acquisition unit 120 acquires an image. The estimation unit 140 estimates the number of target objects included in a target region being at least part of the acquired image by using a learned model. Input data of the model are an image. Output data of the model include likelihood data and numerical data. The likelihood data indicate a likelihood of one or more target objects being included in each of a plurality of partial regions acquired by dividing the image. The numerical data indicate the estimated number of target objects for a partial region estimated to include one or more target objects out of the plurality of partial regions. The estimation unit 140 estimates the number of target objects included in a target region by using the likelihood data and the numerical data.

The estimation apparatus 10 enables high-precision estimation of the number of objects in an image even when a plurality of objects exist close to each other in the image. A detailed example of the estimation apparatus 10 will be described below.

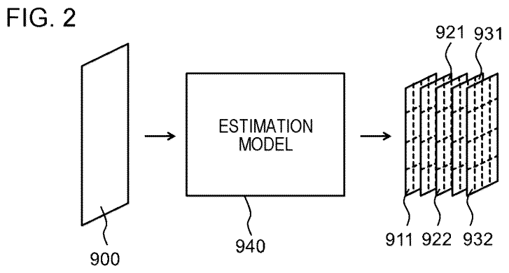

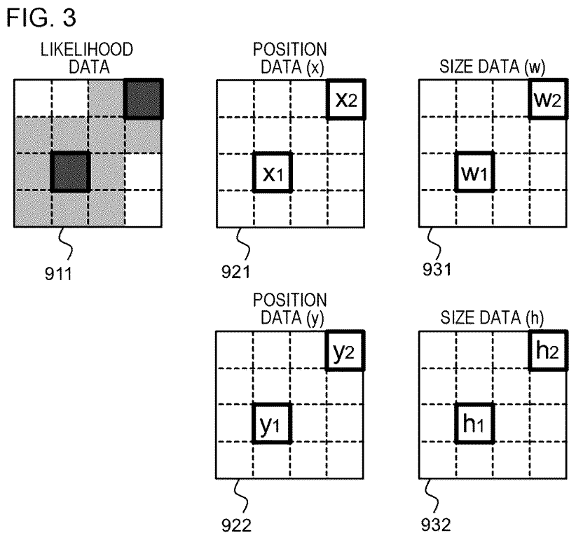

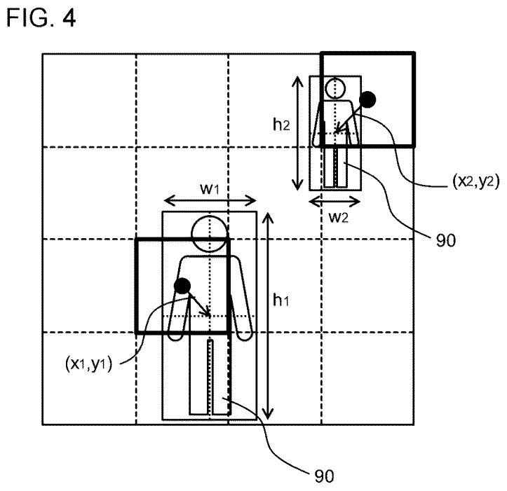

FIG. 2 to FIG. 4 are diagrams for illustrating a comparative example of a method for estimating the number of objects in an image. FIG. 2 is a diagram illustrating an input and an output of an estimation model 940 according to the comparative example. In this comparative example, an image 900 is input to the estimation model 940 including a neural network. Then, likelihood data 911, position data (x) 921, position data (y) 922, size data (w) 931, and size data (h) 932 are output from the estimation model 940. FIG. 3 is a diagram illustrating contents of the likelihood data 911, the position data (x) 921, the position data (y) 922, the size data (w) 931, and the size data (h) 932. FIG. 4 illustrates states of target objects 90 related to the data illustrated in FIG. 3. Note that the center of a partial region is indicated by a black circle in FIG. 4. A subscript of each variable indicated in FIG. 4 indicates a number for identifying a person (target object).

The likelihood data 911 indicate a likelihood in each partial region acquired by dividing the image 900. The likelihood is a likelihood of the center position of a target object being positioned in the partial region. A partial region in a darker color indicates a higher likelihood in the likelihood data 911 in FIG. 3.

For a partial region with a high likelihood, the position data (x) 921 and the position data (y) 922 indicate the position of a target object relative to the center of the partial region. Specifically, when x₁ and y₁ are respectively indicated in the position data (x) 921 and the position data (y) 922 for a certain partial region, a vector from the center of the partial region toward the center of the target object is represented by (x₁, y₁). For a partial region with a high likelihood, the size data (w) 931 and the size data (h) 932 respectively indicate the width (in a lateral direction of the image) and the height (in a longitudinal direction of the image) of a target object.

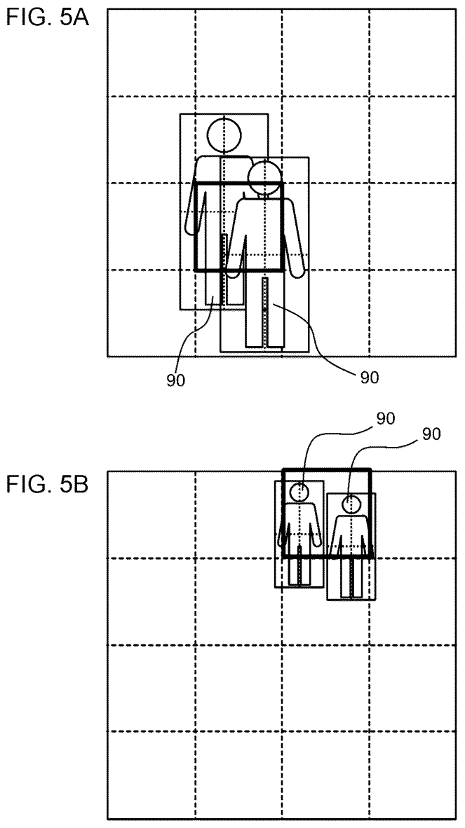

FIG. 5A and FIG. 5B are diagrams for illustrating an issue in the method according to the comparative example. Information about only one target object can be indicated for one partial region in the method according to this comparative example. Therefore, when a plurality of objects are positioned in one region such as when a plurality of objects exist close to each other in an image, the number of objects cannot be accurately estimated by the method according to this comparative example. The issue particularly tends to occur in an image of a congested environment as illustrated in FIG. 5A, in the back part (upper part) of an image acquired by a camera with a shallow depression angle as illustrated in FIG. 5B, and the like.

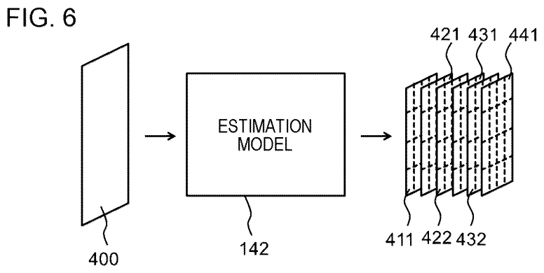

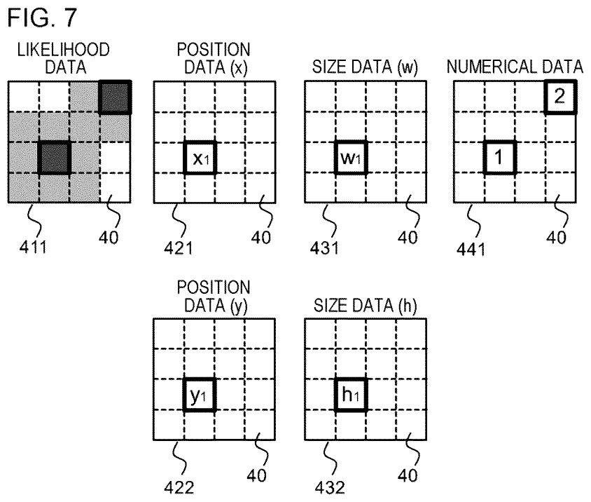

FIG. 6 to FIG. 8 are diagrams for illustrating an example of an estimation method performed by the estimation apparatus 10 according to the present example embodiment. FIG. 6 is a diagram illustrating an input and an output of an estimation model according to the present example embodiment. In the example in FIG. 6, an image 400 is input to an estimation model 142. Then, numerical data 441 are output from the estimation model 142 in addition to likelihood data 411, position data (x) 421, position data (y) 422, size data (w) 431, and size data (h) 432. FIG. 7 is a diagram illustrating contents of the likelihood data 411, the position data (x) 421, the position data (y) 422, the size data (w) 431, the size data (h) 432, and the numerical data 441.

In this example, the numerical data 441 indicate an estimated number of target objects for a partial region with a high likelihood in the likelihood data 411. Information indicating an estimated position of a target object is indicated only for a partial region in which the number of target objects is equal to 1 in the position data (x) 421 and the position data (y) 422. An estimated size of a target object is indicated in the size data (w) 431 and the size data (h) 432 only for a partial region in which the number of target objects is equal to 1.

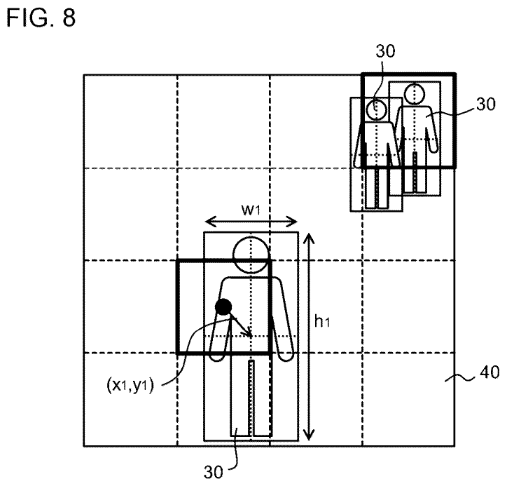

FIG. 8 illustrates states of target objects 30 related to the data illustrated in FIG. 7. Note that a black circle indicates the center of a partial region 40 in FIG. 8. The estimation unit 140 can determine the number of target objects in the image 400 by totaling the numbers of target objects in partial regions indicated in the numerical data 441. Accordingly, even when a partial region in which a plurality of target objects are positioned exists, the method according to the present example embodiment enables accurate estimation of the number of objects by output of the numerical data 441 from the estimation model 142. Furthermore, for a partial region in which the number of target objects 30 is equal to 1, the position and the size of the target object can be determined from the output data of the estimation model 142 in this example.

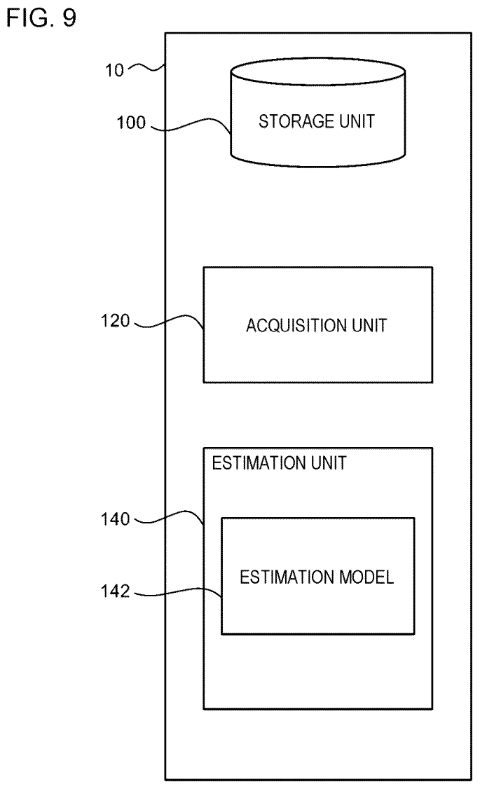

FIG. 9 is a diagram illustrating a functional configuration of the estimation apparatus 10 according to the present example embodiment. Each functional component and each type of data in the estimation apparatus 10 according to the present example embodiment will be described in detail below.

The acquisition unit 120 in the estimation apparatus 10 according to the present example embodiment acquires an image 400. For example, the acquisition unit 120 may read and acquire an image 400 held in a storage unit 100. The storage unit 100 may be provided in the estimation apparatus 10 or outside the estimation apparatus 10. In addition, the acquisition unit 120 may acquire an image 400 directly from an image capture unit such as a camera. An image 400 may or may not include a target object 30. The acquisition unit 120 may acquire an image 400 one by one or may collectively acquire a plurality of images 400. For example, when a user performs operation of inputting an image 400 to the estimation apparatus 10, the acquisition unit 120 acquires the image 400. While not being particularly limited, for example, an image 400 is an image captured by a surveillance camera or a security camera. In this case, the image 400 may be a frame image constituting a video.

While not being particularly limited, for example, a target object 30 may be a living thing such as a human being or an animal, may be a moving body such as a vehicle or a flying body, or may be a static object. Target objects 30 may include a plurality of types of objects. The estimation unit 140 includes a learned estimation model 142. By using the estimation model 142, the estimation unit 140 estimates the number of target objects 30 included in a target region in an image 400 acquired by the acquisition unit 120. A target region may be the entire image 400 or a partial region. A target region may be predetermined or may be specified by a user as will be described in a fourth example embodiment. A case of a target region being an entire image will be described in the present example embodiment.

For example, the estimation model 142 includes a neural network. An input of the estimation model 142 is an image 400, and an output of the estimation model 142 at least includes the likelihood data 411 and the numerical data 441. In the likelihood data 411, a likelihood of one or more target objects 30 being positioned is indicated for each of a plurality of partial regions 40 acquired by dividing the image. In the numerical data 441, an estimated number of target objects 30 is indicated for each of the plurality of partial regions 40. In the examples in FIG. 6 to FIG. 8, each quadrangular region acquired by dividing an image in a grid-like manner by broken lines is a partial region 40. While the shape of a partial region 40 is not particularly limited, a partial region 40 is set in such a way that every point in a target region is included in one of the partial regions 40. Specifically, each piece of the likelihood data 411, the position data (x) 421, the position data (y) 422, the size data (w) 431, the size data (h) 432, and the numerical data 441 output from the estimation model 142 constitutes a map for partial regions 40. While the size of a partial region 40 is not particularly limited, the area of each partial region 40 is preferably equal to or greater than 1/4096 [=1/(64×64)] of the area of the entire image 400 and equal to or less than 1/4 [=1/(2×2)] of the area from the viewpoint of high-precision estimation of the number of target objects 30. How to divide an image 400 into a plurality of partial regions 40 may be predetermined.

For example, a likelihood indicated by the likelihood data 411 is a likelihood of one or more target objects 30 being positioned in a relevant partial region 40. When a reference position of a certain target object 30 is positioned in a partial region 40, the target object 30 can be assumed to be positioned in the partial region 40. For example, a reference position is the center position of a target object 30 in an image 400. The center position of a target object 30 may be the center position of a polygon such as a quadrangle, a perfect circle, or an ellipse enclosing the target object 30 in the image 400. Alternatively, one vertex of a polygon enclosing the target object 30 in the image 400 may be set as a reference position. In other words, the likelihood data indicate a likelihood of reference positions of one or more target objects 30 being positioned in each of a plurality of partial regions 40. The likelihood data may be indicated by a normal distribution or the like in a plurality of partial regions 40 around a partial region 40 in which the center position of the target object 30 is positioned. The likelihood data indicate a likelihood for every partial region 40. A partial region 40 in a darker color indicates a higher likelihood in the likelihood data 411 in FIG. 7.

For example, an estimated number of target objects 30 indicated by the numerical data 441 is an estimated number of target objects 30 reference positions of which are positioned in a relevant partial region 40. Note that in FIG. 7, in order to avoid complication of the diagram, a numerical value is indicated in the numerical data 441 only for a partial region 40 with a high likelihood in the likelihood data 411, that is, a partial region 40 estimated to include one or more target objects 30. Then, in FIG. 7, a region in the numerical data 441 related to a partial region 40 with a non-high likelihood in the likelihood data 411 is left blank. However, some numerical value is actually indicated in the numerical data 441 for every partial region 40. Note that a numerical value indicated in the numerical data 441 for a partial region 40 with a non-high likelihood has low validity as an estimated number, and only a value for a partial region with a high likelihood can be regarded as an estimated number.

Further, the estimation model 142 outputs a plurality of types of data including the numerical data 441. In other words, the neural network in the estimation model 142 includes a plurality of layers outputting a plurality of types of data.

Output data of the estimation model 142 according to the present example embodiment may further include at least one type of data out of position data and size data. The position data in the estimation apparatus 10 according to the present example embodiment indicate an estimated position of a target object 30 only for a partial region 40 with the estimated number of the target object 30 indicated in the numerical data 441 being equal to 1. Further, the size data in the estimation apparatus 10 according to the present example embodiment indicate an estimated size of a target object 30 only for a partial region 40 with the estimated number of target objects 30 indicated in the numerical data 441 being equal to 1. When the position data are included in output data of the estimation model 142, the estimation unit 140 can further estimate the positions of at least part of target objects 30 by using the position data. Further, when the size data are included in output data of the estimation model 142, the estimation unit 140 can further estimate the sizes of at least part of target objects 30 by using the size data. Note that output data of the estimation model 142 may not include the position data and the size data.

The reference position of a target object 30 exists at a certain position in one partial region 40. For example, the position data are composed of first position data and second position data. In the examples in FIG. 6 and FIG. 7, the first position data are the position data (x) 421, and the second position data are the position data (y) 422. The first position data indicate an amount of deviation of the reference position of a target object 30 relative to a reference point of a partial region 40 in a first direction. The second position data indicate an amount of deviation of the reference position of the target object 30 relative to the reference point of the partial region 40 in a second direction. An amount of deviation may take on a positive value, zero, or a negative value. For example, the reference point of a partial region 40 is the center of the partial region 40. Note that when a partial region 40 is a polygon, the reference point of the partial region 40 may be one of the vertices. The reference position of a target object 30 is as described above. The first direction and the second direction are directions different from each other, and for example, the first direction and the second direction intersect at right angles. The first direction in the position data (x) 421 is an x-direction, and the second direction in the position data (y) 422 is a y-direction. Specifically, when xₖ is indicated in the position data (x) 421 for a target object k (k: a number for identifying a target object) positioned in a certain partial region and yₖ is indicated in the position data (y) 422 for the same target object k positioned in the same partial region, a vector from the reference point of the partial region toward the reference position of the target object k (a target object 30 in FIG. 8) is represented by (xₖ, yₖ). Note that a format of data indicating the position of a target object 30 in FIG. 8 is not limited to this format.

For example, the size data are composed of first size data and second size data. In the examples in FIG. 6 and FIG. 7, the first size data are the size data (w) 431, and the second size data are the size data (h) 432. The first size data indicate the width of a target object 30 in a third direction in an image 400. The second size data indicate the height of the target object 30 in a fourth direction in the image 400. The third direction and the fourth direction are directions different from each other, and, for example, the third direction and the fourth direction intersect at right angles. The third direction in the size data (w) 431 is the x-direction, and the fourth direction in the size data (h) 432 is the y-direction. The size of a target object 30 indicated by the size data may be the size of a polygon such as a quadrangle, a perfect circle, or an ellipse enclosing the target object 30 in the image 400. Note that a format of data indicating the size of a target object 30 is not limited to this format.

The position data in the estimation apparatus 10 according to the present example embodiment do not include information indicating an estimated position of a target object 30 for a partial region 40 with the estimated number of target objects 30 indicated in the numerical data 441 being equal to or greater than 2. Further, the size data in the estimation apparatus 10 according to the present example embodiment do not include information indicating an estimated size of a target object 30 for a partial region 40 with the estimated number of target objects 30 in the numerical data 441 being equal to or greater than 2. Note that in FIG. 7, in order to avoid complication of the diagram, each region in the position data (x) 421, the position data (y) 422, the size data (w) 431, and the size data (h) 432 related to a partial region 40 with the estimated number in the numerical data 441 not being equal to 1 is left blank. However, some numerical values are actually indicated in the position data (x) 421, the position data (y) 422, the size data (w) 431, and the size data (h) 432 for all partial regions 40. Note that numerical values indicated in the position data (x) 421 and the position data (y) 422 for a partial region 40 with the estimated number in the numerical data 441 not being equal to 1 have low validity as an estimated position, and only values for a partial region 40 with the estimated number in the numerical data 441 being equal to 1 can be regarded as indicating an estimated position. Further, numerical values indicated in the size data (w) 431 and the size data (h) 432 for a partial region 40 with the estimated number in the numerical data 441 not being equal to 1 have low validity as an estimated size, and only values for a partial region 40 with the estimated number in the numerical data 441 being equal to 1 can be regarded as indicating an estimated size.

The estimation unit 140 inputs an image 400 to an estimation model 142. Then, the estimation unit 140 determines a partial region 40 in which one or more reference positions of target objects 30 exist by using the likelihood data output from the estimation model 142. For example, the estimation unit 140 may determine a partial region 40 with the likelihood indicated in the likelihood data being equal to or greater than a predetermined threshold value as a partial region 40 in which one or more reference positions of target objects 30 exist. According to the example in FIG. 7, “a partial region second from the left and second from the bottom” and “a partial region first from the right and first from the top” are determined as partial regions 40 in each of which one or more reference positions of target objects 30 exist. In the likelihood data 411 and the numerical data 441 in FIG. 7 and in FIG. 8, a partial region 40 in which one or more target objects 30 exist is enclosed by a thick line. When an image 400 in which a plurality of target objects 30 are included is input, a partial region 40 in which each of the plurality of target objects 30 is positioned is determined. Next, the estimation unit 140 determines an estimated number of target objects 30 indicated in the numerical data 441 for the determined partial region 40. Then, by totaling the estimated numbers of target objects 30 for all determined partial regions 40, the estimation unit 140 computes an estimated value of the number of target objects 30 in the image 400.

The estimation unit 140 may further determine a partial region 40 with the estimated number of target objects 30 being equal to 1 out of the partial regions 40 each determined as a partial region 40 with the estimated number of target objects 30 being equal to or greater than 1. In the position data and the size data in FIG. 7, a partial region 40 with the estimated number of target objects 30 being equal to 1 is enclosed by a thick line. Then, for a partial region 40 with the estimated number of target objects 30 being equal to 1, the estimation unit 140 may determine the reference position of the target object 30 by using the position data. Specifically, for example, the estimation unit 140 determines coordinates of the reference point of the partial region 40 and, by adding amounts of deviation indicated in the position data (x) 421 and the position data (y) 422 to the coordinates, determines the reference position of the target object 30 in the image 400. Further, for a partial region 40 with the estimated number of target objects 30 being equal to 1, the estimation unit 140 may determine the size of the target object 30 by using the size data. Specifically, for example, the estimation unit 140 determines the size of the target object 30 in two directions by using the size data (w) 431 and the size data (h) 432.

The estimation unit 140 outputs an estimation result. Without being particularly limited, an output destination may be a display, a projector, a printer, an electronic mail, or the like or may be a storage apparatus provided inside or outside the estimation apparatus 10. The estimation unit 140 outputs at least the number of target objects 30 as the estimation result. The estimation unit 140 may output output data in themselves from the estimation model 142 as the estimation result. The estimation unit 140 may output the number of target objects 30 as a numerical value or as an image. For example, the estimation unit 140 may generate and output an output image in which a mark indicating a target object 30 is displayed on a map indicating partial regions 40, as illustrated in FIG. 8. The mark may be an illustration indicating a target object 30 in addition to a figure such as a quadrangle or a circle. Further, the estimation unit 140 may generate and output an output image in which a mark indicating a target object 30 is displayed on the image 400 by superimposition. For example, in an output image, marks the number of which corresponds to the number of target objects 30 in each partial region 40 are indicated at a position related to the partial region 40. Alternatively, in an output image, a numerical value indicating the number of target objects 30 may be displayed at a position related to each partial region 40. The color of a mark or a numerical value to be displayed may be varied according to the number of target objects 30 for each partial region 40. The color of each partial region 40 may be varied according to the number of target objects 30 positioned in the partial region 40.

Further, for a target object 30 the position of which is determined by the estimation unit 140 by using the position data, a mark indicating the target object 30 is displayed at the determined position. For a target object 30 the position of which is not determined by the estimation unit 140, a mark indicating the target object 30 is displayed at a predetermined position in the partial region 40. Note that when a plurality of marks are displayed in one partial region 40, the display positions are determined according to the number of target objects 30 in such a way that the marks do not completely overlap each other.

Further, for a target object 30 the size of which is determined by the estimation unit 140 by using the size data, a mark indicating the target object 30 is displayed in the determined size. For a target object 30 the size of which is not determined by the estimation unit 140, a mark indicating the target object 30 is displayed in a predetermined size in the partial region 40.

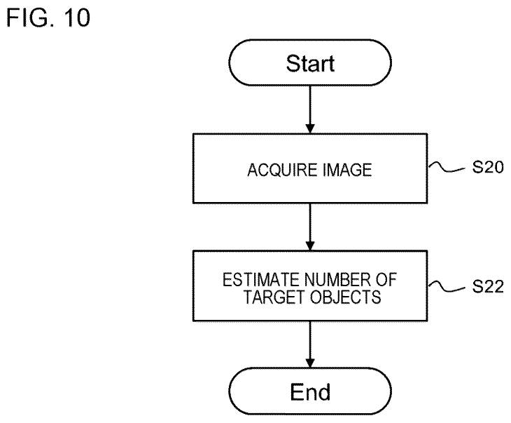

FIG. 10 is a flowchart illustrating an overview of the estimation method executed by the estimation apparatus 10 according to the present example embodiment. The method is an estimation method executed by one or more computers. The estimation method according to the present example embodiment includes Step S20 of acquiring an image 400 and Step S22 of estimating the number of target objects 30. In Step S22 of estimating the number of target objects 30, the number of target objects 30 included in a target region being at least part of the acquired image 400 is estimated by using the learned estimation model 142. Input data of the estimation model 142 are the image 400, and output data of the estimation model 142 include the likelihood data 411 and the numerical data 441. The likelihood data 411 are data indicating a likelihood of one or more target objects 30 being included in each of a plurality of partial regions 40 acquired by dividing the image 400. The numerical data 441 are data indicating an estimated number of target objects 30 for a partial region 40 estimated to include one or more target objects 30 out of the plurality of partial regions 40. In Step S22, estimation of the number of target objects 30 included in a target region is performed by using the likelihood data 411 and the numerical data 441.

A hardware configuration of the estimation apparatus 10 will be described below. Each functional component in the estimation apparatus 10 may be provided by hardware (example: a hard-wired electronic circuit) providing the functional component or may be provided by a combination of hardware and software (example: a combination of an electronic circuit and a program controlling the circuit). A case of each functional component in the estimation apparatus 10 being provided by a combination of hardware and software will be further described below.

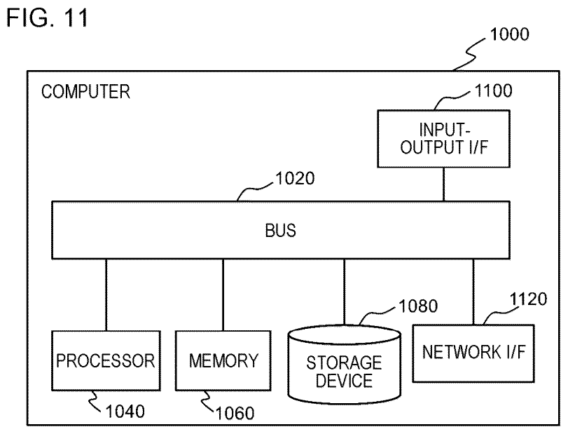

FIG. 11 is a diagram illustrating a computer 1000 for providing the estimation apparatus 10. The computer 1000 may be any computer. Examples of the computer 1000 include a system-on-chip (SoC), a personal computer (PC), a server machine, a tablet terminal, and a smartphone. The computer 1000 may be a dedicated computer designed for providing the estimation apparatus 10 or may be a general-purpose computer.

The computer 1000 includes a bus 1020, a processor 1040, a memory 1060, a storage device 1080, an input-output interface 1100, and a network interface 1120. The bus 1020 is a data transmission channel for the processor 1040, the memory 1060, the storage device 1080, the input-output interface 1100, and the network interface 1120 to transmit and receive data to and from one another. Note that the method for interconnecting the processor 1040 and other components is not limited to a bus connection. Examples of the processor 1040 include various processors such as a central processing unit (CPU), a graphics processing unit (GPU), and a field-programmable gate array (FPGA). The memory 1060 is a main storage provided by using a random-access memory (RAM) or the like. The storage device 1080 is an auxiliary storage provided by using a hard disk, a solid-state drive (SSD), a memory card, a read-only memory (ROM) or the like.

The input-output interface 1100 is an interface for connecting the computer 1000 to input/output devices. For example, the input-output interface 1100 is connected to an input apparatus such as a keyboard and an output apparatus such as a display.

The network interface 1120 is an interface for connecting the computer 1000 to a network. Examples of the communication network include a local area network (LAN) and a wide area network (WAN). The method for connecting the network interface 1120 to the network may be a wireless connection or a wired connection.

The storage device 1080 stores a program module providing each functional component in the estimation apparatus 10. The processor 1040 provides a function related to each program module by reading the program module into the memory 1060 and executing the program module.

Further, when the storage unit 100 is provided inside the estimation apparatus 10, for example, the storage unit 100 is provided by using the storage device 1080.

### Model Generation Apparatus

Generation of the estimation model 142 used in the estimation unit 140 in the estimation apparatus 10 according to the present example embodiment will be described below. The estimation model 142 may be generated by using a model generation apparatus 20 as described below.

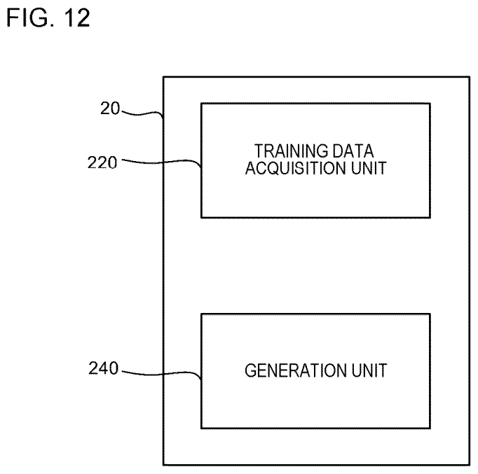

FIG. 12 is a diagram illustrating an overview of the model generation apparatus 20 according to the present example embodiment. The model generation apparatus 20 according to the present example embodiment includes a training data acquisition unit 220 and a generation unit 240. The training data acquisition unit 220 acquires training data in which a training image and ground truth data are associated with each other. The generation unit 240 generates the estimation model 142 by performing machine learning using training data. Input data of the estimation model 142 are an image. Output data of the estimation model 142 include the likelihood data 411 and the numerical data 441. The likelihood data 411 are data indicating a likelihood of one or more target objects being included in each of a plurality of partial regions acquired by dividing the image. The numerical data 441 are data indicating an estimated number of target objects for a partial region estimated to include one or more target objects out of the plurality of partial regions.

Target objects 30 are as described above for the estimation apparatus 10 and may be one type of object or a plurality of types of objects.

A training image may include only one target object 30 or a plurality of target objects 30. For example, ground truth data are a ground truth label indicating a figure representing each target object 30 in a related training image. A figure indicating a target object 30 may be a polygon such as a quadrangle or may be a perfect circle, an ellipse, or the like. The position and the size of a figure are respectively the position and the size in which a target object 30 is enclosed. The ground truth data may indicate a reference position and the size of a figure indicating a target object 30. The reference position of a figure may be the center of the FIG. or may be one of the vertices of the figure or the like. Further, for example, the ground truth data may include another type of information such as an attribute of a target object 30.

In addition, the ground truth data may be data in a format similar to that of output data of the estimation model 142. Specifically, the ground truth data may include ground truth likelihood data indicating a likelihood of one or more target objects 30 being included in each of a plurality of partial regions in a training image. A likelihood of each region in the ground truth likelihood data may take on “1” or “0.” Further, the ground truth data may include ground truth numerical data indicating the number of target objects for a partial region in which one or more target objects exist out of a plurality of partial regions acquired by dividing a training image. The ground truth numerical data are data structured similarly to the aforementioned numerical data 441. Further, the ground truth data may include ground truth position data indicating the position of a target object 30 for a partial region with the number of target objects 30 indicated in the ground truth numerical data being equal to 1 or a partial region with the number of target objects 30 being equal to or greater than 1. The ground truth data may include ground truth size data indicating the size of a target object 30 for a partial region with the number of target objects indicated in the ground truth numerical data being equal to 1 or a partial region with the number of target objects being equal to or greater than 1. Any value may be indicated in the ground truth numerical data, the ground truth position data, and the ground truth size data for a partial region in which a target object does not exist.

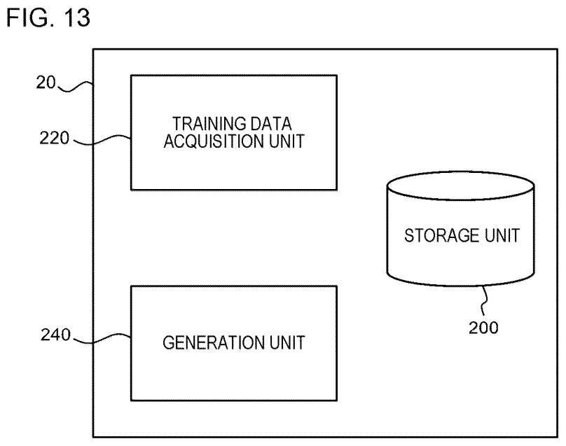

FIG. 13 is a block diagram illustrating a functional configuration of the model generation apparatus 20 according to the present example embodiment. Ground truth data may be previously generated and be held in a storage unit 200 in association with a training image. For example, by performing operation of specifying the aforementioned figure on a target object 30 appearing in a training image by a user, ground truth data for the training image are generated. The exemplified data other than a figure in the ground truth data may be automatically generated based on the figure.

A plurality of pieces of training data in which a training image and ground truth data are associated with each other are held in the storage unit 200. The training data acquisition unit 220 may read and acquire training data from the storage unit 200. The storage unit 200 may be provided in the model generation apparatus 20 or be provided outside the model generation apparatus 20.

The generation unit 240 generates the learned estimation model 142 by performing machine learning using training data acquired by the training data acquisition unit 220. An example of processing performed by the generation unit 240 is as follows.

The storage unit 200 stores the estimation model 142. The generation unit 240 reads the estimation model 142 from the storage unit 200 and performs machine learning. Output data of the estimation model 142 include the likelihood data 411 and the numerical data 441. The output data of the estimation model 142 may further include one or more types of data out of position data and size data. The position data and the size data are as described above in relation to the estimation apparatus 10.

The generation unit 240 performs machine learning in such a way that the estimation model 142 outputs likelihood data. As for likelihood data, for example, the generation unit 240 adjusts a parameter of the estimation model 142 in such a way as to minimize the error between likelihood data output from the estimation model 142 during learning and the ground truth likelihood data.

The generation unit 240 performs machine learning in such a way that, for a partial region in which one or more target objects exist, the estimation model 142 outputs the number of target objects 30 in the partial region. Specifically, for example, when performing learning related to the number of target objects 30 positioned in each partial region, the generation unit 240 determines a partial region with the likelihood indicated in the ground truth likelihood data being equal to 1 or a partial region with the likelihood being equal to or greater than a predetermined threshold value. Then, the generation unit 240 adjusts the parameter of the estimation model 142 in such a way as to minimize the error between the number of target objects 30 output from the estimation model 142 during learning and the ground truth numerical data for the determined partial region. Thus, machine learning is performed in such a way that the estimation model 142 outputs the number of target objects 30 only for a partial region in which one or more target objects exist. Note that the generation unit 240 may determine a ground truth of the number of target objects 30 from the aforementioned ground truth label and use the information in learning.

As for the position of a target object 30, the generation unit 240 performs machine learning in such a way that the estimation model 142 outputs the position of a target object 30 only for a partial region with the number of target objects 30 being equal to 1. Specifically, for example, when performing learning related to the position of a target object 30 positioned in each partial region, the generation unit 240 determines a partial region with the number of target objects 30 in the ground truth numerical data being equal to 1. Then, the generation unit 240 adjusts the parameter of the estimation model 142 in such a way as to minimize the error between the position of the target object 30 indicated in the position data output from the estimation model 142 during learning and the position of the target object 30 indicated in the ground truth position data for the determined partial region. Note that the generation unit 240 may determine ground truths of the number and the positions of target objects 30 from the aforementioned ground truth label and use the information in learning.

As for the size of a target object 30, the generation unit 240 performs machine learning in such a way that the estimation model 142 outputs the size of a target object 30 only for a partial region with the number of target objects being equal to 1. Specifically, for example, when performing learning related to the size of a target object 30 positioned in each partial region, the generation unit 240 determines a partial region with the number of target objects 30 in the ground truth numerical data being equal to 1. Then, the generation unit 240 adjusts the parameter of the estimation model 142 in such a way as to minimize the error between the size of the target object 30 indicated in the size data output from the estimation model 142 during learning and the size of the target object 30 indicated in the ground truth size data for the determined partial region. Note that the generation unit 240 may determine ground truths of the number and the sizes of target objects 30 from the aforementioned ground truth label and use the information in learning.

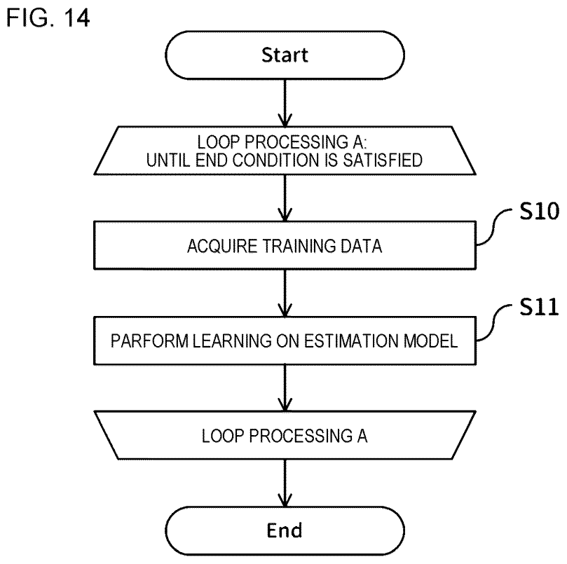

FIG. 14 is a flowchart illustrating a flow of a model generation method executed by the model generation apparatus 20 according to the present example embodiment. The method is a model generation method executed by one or more computers. The model generation method according to the present example embodiment includes Step S10 of acquiring training data in which a training image and ground truth data are associated with each other and Step S11 of performing learning of the estimation model 142 by performing machine learning using the training data. Input data of the estimation model 142 are an image. Output data of the estimation model 142 include the likelihood data 411 and the numerical data 441. The likelihood data 411 are data indicating a likelihood of one or more target objects being included in each of a plurality of partial regions acquired by dividing an image. The numerical data 441 are data indicating an estimated number of target objects for a partial region estimated to include one or more target objects out of the plurality of partial regions.

In the model generation method according to the present example embodiment, a loop including Step S10 and Step S11 is repeated until an end condition is satisfied. For example, the end condition is a value acquired by a loss function being equal to or less than a predetermined value.

A hardware configuration of a computer providing the model generation apparatus 20 according to the present example embodiment is represented by, for example, FIG. 11, similarly to the estimation apparatus 10. Note that program modules providing the functions of the model generation apparatus 20 according to the present example embodiment are stored in a storage device 1080 in a computer 1000 providing the model generation apparatus 20 according to the present example embodiment. Further, when the storage unit 200 is provided inside the model generation apparatus 20, for example, the storage unit 200 is provided by using the storage device 1080.

As described above, output data of the estimation model 142 include the likelihood data 411 and the numerical data 441, according to the present example embodiment. Accordingly, high-precision estimation of the number of objects in an image is enabled even when a plurality of objects exist close to each other in the image.

### Second Example Embodiment

### Estimation Apparatus

An estimation apparatus 10 according to a second example embodiment is the same as the estimation apparatus 10 according to the first example embodiment except for points described below. An estimation model 142 according to the second example embodiment outputs position data. The position data output by the estimation model 142 indicate an estimated mean position of one or more target objects (a set of target objects) for a partial region with the estimated number of target objects indicated in numerical data being equal to or greater than 1. Further, the estimation model 142 according to the present example embodiment outputs size data. The size data output by the estimation model 142 indicate an estimated size of a region including one or more target objects for a partial region with the estimated number of target objects indicated in the numerical data being equal to or greater than 1. Details will be described below.

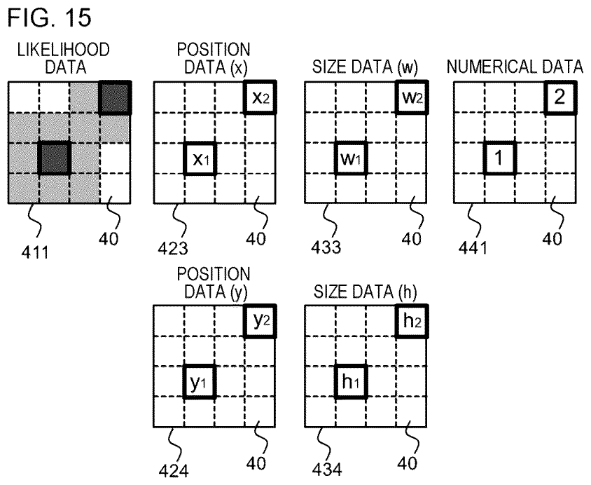

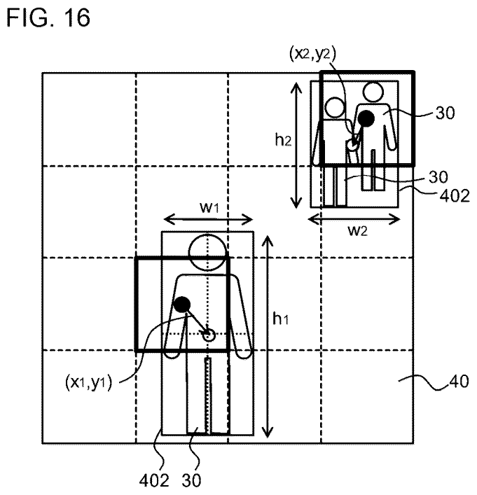

FIG. 15 is a diagram illustrating data output by the estimation model 142 in the estimation apparatus 10 according to the present example embodiment. FIG. 16 is a diagram illustrating states of target objects 30 related to the data illustrated in FIG. 15. In the example in FIG. 15, estimated values are indicated in position data and size data also for a partial region 40 with the estimated number of target objects 30 indicated in numerical data 441 being 2. A partial region 40 in which one or more target objects 30 exist is enclosed by a thick line in FIG. 15 and FIG. 16.

For example, the position data are composed of first position data and second position data. In the example in FIG. 15, the first position data are position data (x) 423, and the second position data are position data (y) 424. The first position data indicate an amount of deviation of the mean position of target objects 30 relative to a reference point of a partial region 40 in a first direction. The second position data indicate an amount of deviation of the mean position of the target objects 30 relative to the reference point of the partial region 40 in a second direction. The reference point of a partial region 40, the first direction, and the second direction are as described in the first example embodiment. The mean position of one or more target objects 30 is determined by the mean position of the reference positions of the one or more target objects 30 in the first direction and the mean position of the reference positions of the one or more target objects 30 in the second direction. A mean position is indicated by an open circle in FIG. 16. When xₖ is indicated in the position data (x) 423 for a set k of target objects positioned in a certain partial region (k: a number for identifying a set of target objects) and yₖ is indicated in the position data (y) 424 for the same set k of target objects positioned in the same partial region, a vector from the reference point of the partial region toward the mean position of the set k of target objects (the set of target objects 30 in FIG. 16) is represented by (xₖ, yₖ). Note that a format of data indicating the position of a set of target objects 30 is not limited to this format. Note that for a partial region 40 with the number of target objects 30 being equal to 1, the reference position of one target object 30 directly becomes a mean position, and therefore a value indicated for the partial region 40 is unchanged from that in the first example embodiment.

For example, the size data are composed of first size data and second size data. In the example in FIG. 15, the first size data are size data (w) 433, and the second size data are size data (h) 434. The first size data indicate the width of a region 402 including one or more target objects 30 in a third direction in an image 400. The second size data indicate the height of the region 402 including one or more target objects 30 in a fourth direction in the image 400. The third direction and the fourth direction are as described in the first example embodiment. The outer edge of the region 402 including one or more target objects 30 is circumscribed on a region occupied by the one or more target objects 30 in the image 400. While not being particularly limited, for example, the shape of the region 402 including the one or more target objects 30 may be a polygon such as a quadrangle, or a perfect circle or an ellipse.

Note that in FIG. 15, in order to avoid complication of the diagram, each region in position data (x) 421, position data (y) 422, size data (w) 431, and size data (h) 432 related to a partial region 40 with the estimated number in the numerical data 441 being not equal to or greater than 1 or a partial region 40 with the likelihood in the likelihood data 411 being less than a predetermined threshold value is left blank. However, some numerical values are actually indicated in the position data (x) 421, the position data (y) 422, the size data (w) 431, and the size data (h) 432 for all partial regions 40. Note that numerical values indicated in the position data (x) 421 and the position data (y) 422 for a partial region 40 with the estimated number in the numerical data 441 being not equal to or greater than 1 or a partial region 40 with the likelihood in the likelihood data 411 being less than the predetermined threshold value have low validity as an estimated position, and only values for a partial region 40 with the likelihood in the likelihood data 411 being equal to or greater than the predetermined threshold value and an estimated number in the numerical data 441 being equal to or greater than 1 can be regarded as indicating an estimated position. Further, numerical values indicated in the size data (w) 431 and the size data (h) 432 for a partial region 40 with the estimated number in the numerical data 441 not being equal to or greater than 1 or a partial region 40 with the likelihood in the likelihood data 411 being less than the predetermined threshold value have low validity as an estimated size, and only values for a partial region 40 with the likelihood in the likelihood data 411 being equal to or greater than the predetermined threshold value and an estimated number in the numerical data 441 being equal to or greater than 1 can be regarded as indicating an estimated size.

The estimation model 142 according to the present example embodiment can also estimate the number of target objects 30, similarly to that according to the first example embodiment. Further, the present example embodiment enables acquisition of estimated information related to the position and the size of a target object 30 also for a partial region 40 with the estimated number of target objects 30 being equal to or greater than 2.

For a partial region 40 determined to be a partial region 40 with the estimated number of target objects 30 being equal to or greater than 1 by using the likelihood data 411, an estimation unit 140 can determine the mean position of one or more target objects 30 for each partial region 40 by using the position data. Specifically, for example, the estimation unit 140 determines the mean position of one or more target objects 30 in the image 400 by determining coordinates of the reference point of a partial region 40 and adding amounts of deviation indicated in the position data (x) 423 and the position data (y) 424 to the coordinates. Further, for a partial region 40 with the estimated number of target objects 30 being equal to or greater than 1, the estimation unit 140 can determine the size of a region 402 including one or more target objects 30 for each partial region 40 by using the size data. Specifically, for example, the estimation unit 140 determines the size of the region 402 including one or more target objects 30 in two directions by using the size data (w) 433 and the size data (h) 434.

Further, for a partial region 40 in which one or more target objects 30 are estimated to be positioned, marks indicating the one or more target objects 30 are displayed in an output image for each partial region 40 in such a way that the mean position of the one or more target objects 30 is the position determined by the estimation unit 140. Further, for a partial region 40 in which one or more target objects 30 are estimated to be positioned, marks indicating the one or more target objects 30 are displayed in the output image for each partial region 40 in such a way that the size of a region 402 including the one or more target objects 30 is the size determined by the estimation unit 140.

### Model Generation Apparatus

Generation of the estimation model 142 used in the estimation unit 140 in the estimation apparatus 10 according to the present example embodiment will be described below. The estimation model 142 may be generated by using a model generation apparatus 20 as described below. The model generation apparatus 20 according to the second example embodiment is the same as the model generation apparatus 20 according to the first example embodiment except for points described below. The estimation model 142 according to the second example embodiment outputs position data. For a partial region with the estimated number of target objects indicated in the numerical data being equal to or greater than 1, the position data output by the estimation model 142 indicate an estimated mean position of the one or more target objects. Further, the estimation model 142 according to the present example embodiment outputs size data. For a partial region with the estimated number of target objects indicated in the numerical data being equal to or greater than 1, the size data output by the estimation model 142 indicate an estimated size of a region including one or more target objects. Details will be described below.

For a partial region with the number of target objects 30 being equal to or greater than 1, a generation unit 240 in the model generation apparatus 20 according to the present example embodiment performs machine learning in such a way that the estimation model 142 outputs the mean position of the one or more target objects 30. Specifically, for example, when performing learning related to the position of a target object 30 positioned in each partial region, the generation unit 240 determines a partial region with the likelihood indicated in ground truth likelihood data being equal to 1, a partial region with the likelihood indicated in the ground truth likelihood data being equal to or greater than a predetermined threshold value, or a partial region with the number of target objects 30 in ground truth numerical data being equal to or greater than 1. Then, the generation unit 240 adjusts a parameter of the estimation model 142 in such a way as to minimize the error between a mean position indicated in the position data output from the estimation model 142 during learning and a mean position indicated in the ground truth position data for the determined partial region. The ground truth position data according to the present example embodiment are structured similarly to the position data according to the present example embodiment. Note that the generation unit 240 may determine ground truths of the number and the mean position of one or more target objects 30 in each partial region from the aforementioned ground truth label and use the information in learning.

As for the size of a target object 30, the generation unit 240 performs machine learning in such a way that, for a partial region with the number of target objects 30 being equal to or greater than 1, the estimation model 142 outputs the size of a region 402 including the one or more target objects 30. Specifically, for example, when performing learning related to the size of a target object 30 positioned in each partial region, the generation unit 240 determines a partial region with the likelihood indicated in the ground truth likelihood data being equal to 1, a partial region with the likelihood indicated in the ground truth likelihood data being equal to or greater than the predetermined threshold value, or a partial region having the number of target objects 30 in the ground truth numerical data being equal to or greater than 1. Then, the generation unit 240 adjusts the parameter of the estimation model 142 in such a way as to minimize the error between the size of the region 402 indicated in the size data output from the estimation model 142 during learning and the size of the region 402 indicated in the ground truth size data for the determined partial region. The ground truth size data according to the present example embodiment are structured similarly to the size data according to the present example embodiment. Note that the generation unit 240 may determine ground truths of the number and the sizes of one or more target objects 30 in each partial region from the aforementioned ground truth label and use the information in learning.

Next, advantageous effects of the present example embodiment will be described. The present example embodiment provides advantageous effects similar to those of the first example embodiment. In addition, for a partial region with the estimated number of target objects indicated in the numerical data being equal to or greater than 1, the estimation model 142 outputs position data indicating an estimated mean position of the one or more target objects. Further, for a partial region with the estimated number of target objects indicated in the numerical data being equal to or greater than 1, the estimation model 142 outputs size data indicating an estimated size of a region including the one or more target objects. Accordingly, even for a partial region 40 with the number of target objects 30 being equal to or greater than 2, estimated information related to the positions and the sizes of the target objects 30 is acquired.

### Third Example Embodiment

### Estimation Apparatus

An estimation apparatus 10 according to a third example embodiment is the same as the estimation apparatus 10 according to the first or second example embodiment except for a point described below. Output data of an estimation model 142 according to the third example embodiment include likelihood data for each type of target object 30.

Likelihood data according to the present example embodiment are provided for each type of target object 30. This means that, for example, likelihood data indicating a likelihood of an automobile being included as a target object 30 in each of a plurality of partial regions, likelihood data indicating a likelihood of a person being included as a target object 30 in each partial region, and likelihood data indicating a likelihood of a two-wheeled vehicle being included as a target object 30 in each partial region are separately included in output data.

Numerical data 441 included in output data of the estimation model 142 according to the present example embodiment can indicate a total estimated number of a plurality of types of target objects 30 for each partial region 40. By using likelihood data for each type of target object 30, an estimation unit 140 can determine the type of target object 30 positioned in each partial region 40. For example, the estimation unit 140 determines a partial region with the likelihood indicated in each piece of likelihood data being equal to or greater than a predetermined threshold value to be a partial region in which one or more of each type of target object 30 are positioned. Then, for the determined partial region, the estimation unit 140 determines an estimated number indicated in the numerical data 441 to be the total number of all types of target objects 30 in the partial region. The total number is the total of the numbers of all types of target objects 30 being counting targets in the partial region. Further, the estimation model 142 can determine the position and the size of a target object 30 for each partial region 40 in which the target object 30 is positioned, similarly to the first or second example embodiment.

For a partial region j in which one or more target objects 30 are positioned, the estimation unit 140 can further determine the types of the target objects 30. Specifically, for the partial region j in which one or more target objects 30 are positioned, that is, the partial region j with an estimated total number being equal to or greater than 1, the estimation unit 140 determines the type of target object 30 for which the likelihood indicated in each piece of likelihood data is equal to or greater than a predetermined threshold value. Thus, an estimated total number in the partial region j is recognized to be composed of the determined type of target object 30, and the type of target object 30 in the partial region j can be determined.

In an output image generated by the estimation unit 140 according to the present example embodiment, a mark indicating a target object 30 may be varied for each type of target object 30.

### Model Generation Apparatus

Generation of the estimation model 142 used in the estimation unit 140 in the estimation apparatus 10 according to the present example embodiment will be described below. The estimation model 142 may be generated by using a model generation apparatus 20 as described below. The model generation apparatus 20 according to the third example embodiment is the same as the model generation apparatus 20 according to the first or second example embodiment except for a point described below.

According to the present example embodiment, ground truth data such as a ground truth label include information indicating the type of each target object 30 included in a training image. The information indicating the type of target object 30 may be an identifier. Alternatively, the ground truth data may include ground truth likelihood data for each type of target object 30. The generation unit 240 performs machine learning in such a way that the estimation model 142 outputs likelihood data for each type of target object 30. For example, in learning of likelihood data, the generation unit 240 adjusts a parameter of the estimation model 142 in such a way as to minimize the error between a certain type of likelihood data output from the estimation model 142 during learning and ground truth likelihood data for the type.

For other types of data output by the estimation model 142, learning can be similarly performed in accordance with the description in the first or second example embodiment without distinction between types of target objects 30.

Next, advantageous effects of the present example embodiment will be described. The present example embodiment provides advantageous effects similar to those of the first example embodiment. In addition, output data of the estimation model 142 according to the present example embodiment include likelihood data for each type of target object 30. Accordingly, the type of target object 30 included in each partial region 40 can be estimated.

### Fourth Example Embodiment

An estimation apparatus 10 according to a fourth example embodiment is the same as at least one of the first to third example embodiments except for a point described below.

A user performs operation of specifying a target region in an image 400 on the estimation apparatus 10 according to the present example embodiment. Then, an estimation unit 140 acquires information indicating the specified target region. Then, the estimation unit 140 estimates and outputs the number of target objects 30 in the specified target region. Note that the target region may be a predetermined region in the image 400. Further, the user may specify the entire image 400 as a target region. An example of specifying only part of the image 400 as a target region for which the number of target objects 30 is estimated will be described below.

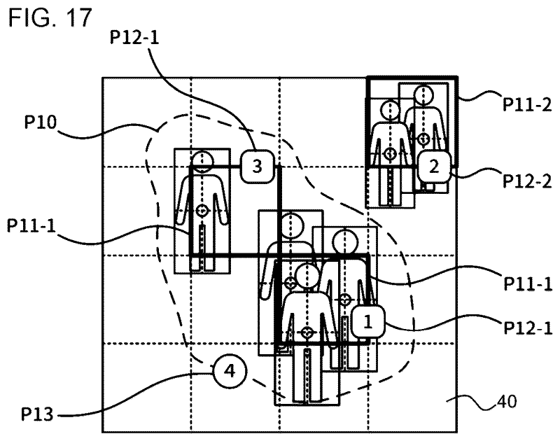

FIG. 17 is a diagram for illustrating a processing example in the estimation unit 140 according to the present example embodiment. For example, the estimation unit 140 determines partial regions 40 (P11-1 and P11-2) each with the estimated number of target objects 30 being equal to or greater than 1 by using likelihood data 411 and numerical data 441 output from an estimation model 142. Then, the estimation unit 140 extracts the partial regions 40 (P11-1) included in a target region (P10) from the determined partial regions 40. Then, the estimation unit 140 computes the number of target objects 30 (P13) in the target region by totaling the estimated numbers (P12-1) of target objects 30 in the extracted partial regions 40 out of the estimated numbers (P12-1 and P12-2) of target objects 30 in the partial regions 40.

The estimation model 142 generated by the model generation apparatus 20 according to at least one of the first to third example embodiments can be used in the estimation apparatus 10 according to the present example embodiment.

The estimation apparatus 10 according to the present example embodiment enables estimation of the number of target objects 30 in a desired region in an image 400.

While the example embodiments of the present invention have been described above with reference to the drawings, the example embodiments are exemplifications of the present invention, and various configurations other than those described above may be employed.

Further, the aforementioned example embodiments may be combined without contradicting one another.

The whole or part of the example embodiments disclosed above may also be described as, but not limited to, the following supplementary notes.
1-1. An estimation apparatus including:
   an acquisition unit that acquires an image; and
   an estimation unit that estimates a number of at least one target object included in a target region being at least part of the acquired image by using a learned model, wherein
   input data of the model are the image,
   output data of the model include:
      likelihood data indicating a likelihood of the one or more target objects being included in each of a plurality of partial regions acquired by dividing the image; and
      numerical data indicating an estimated number of the at least one target object for the partial region estimated to include the one or more target objects out of the plurality of partial regions, and
   the estimation unit estimates a number of the at least one target object included in the target region by using the likelihood data and the numerical data.
1-2. The estimation apparatus according to 1-1., wherein
   the output data further include position data indicating an estimated position of the target object for the partial region with an estimated number of the at least one target object indicated in the numerical data being equal to 1 or the partial region with the estimated number being equal to or greater than 1 and size data indicating an estimated size of the target object for the partial region with an estimated number of the at least one target object indicated in the numerical data being equal to 1 or the partial region with the estimated number being equal to or greater than 1, and
   the estimation unit estimates a position and a size of the target object by using the position data and the size data.
1-3. The estimation apparatus according to 1-2., wherein
   the position data indicate an estimated position of the target object only for the partial region with an estimated number of the at least one target object indicated in the numerical data being equal to 1, and
   the size data indicate an estimated size of the target object only for the partial region with an estimated number of the at least one target object indicated in the numerical data being equal to 1.
1-4. The estimation apparatus according to 1-2., wherein
   the position data indicate an estimated mean position of the one or more target objects for the partial region with an estimated number of the at least one target object indicated in the numerical data being equal to or greater than 1, and
   the size data indicate an estimated size of a region including the one or more target objects for the partial region with an estimated number of the at least one target object indicated in the numerical data being equal to or greater than 1.
1-5. The estimation apparatus according to any one of 1-1. to 1-4., wherein
   the output data include the likelihood data for each type of the target object.
2-1. A model generation apparatus including:
   a training data acquisition unit that acquires training data in which a training image and ground truth data are associated with each other; and
   a generation unit that generates a model by performing machine learning using the training data, wherein
   input data of the model are an image, and
   output data of the model include:
      likelihood data indicating a likelihood of one or more target objects being included in each of a plurality of partial regions acquired by dividing the image; and
      numerical data indicating an estimated number of the at least one target object for the partial region estimated to include the one or more target objects out of the plurality of partial regions.
2-2. The model generation apparatus according to 2-1., wherein
   the ground truth data include ground truth numerical data indicating a number of the at least one target object in each of a plurality of partial regions acquired by dividing the training image.
2-3. The model generation apparatus according to 2-1. or 2-2., wherein,
   the generation unit performs machine learning in such a way that the model outputs a number of the at least one target object in the partial region for the partial region in which the one or more target objects exist.
2-4. The model generation apparatus according to 2-3., wherein
   the generation unit performs machine learning in such a way that the model outputs a position and a size of the target object for the partial region with a number of the at least one target object being equal to 1.
2-5. The model generation apparatus according to 2-3., wherein,
   the generation unit performs machine learning in such a way that the model outputs a mean position of the one or more target objects and a size of a region including the one or more target objects for the partial region with a number of the at least one target object being equal to or greater than 1.
3-1. An estimation method including, by one or more computers:
   acquiring an image; and
   estimating a number of at least one target object included in a target region being at least part of the acquired image by using a learned model, wherein
   input data of the model are the image,
   output data of the model include:
      likelihood data indicating a likelihood of the one or more target objects being included in each of a plurality of partial regions acquired by dividing the image; and
      numerical data indicating an estimated number of the at least one target object for the partial region estimated to include the one or more target objects out of the plurality of partial regions, and
   estimation of a number of the at least one target object included in the target region is performed by using the likelihood data and the numerical data.
3-2. The estimation method according to 3-1., wherein
   the output data further include position data indicating an estimated position of the target object for the partial region with an estimated number of the at least one target object indicated in the numerical data being equal to 1 or the partial region with the estimated number being equal to or greater than 1 and size data indicating an estimated size of the target object for the partial region with an estimated number of the at least one target object indicated in the numerical data being equal to 1 or the partial region with the estimated number being equal to or greater than 1, and
   the one or more computers estimate a position and a size of the target object by using the position data and the size data.
3-3. The estimation method according to 3-2., wherein
   the position data indicate an estimated position of the target object only for the partial region with an estimated number of the at least one target object indicated in the numerical data being equal to 1, and
   the size data indicate an estimated size of the target object only for the partial region with an estimated number of the at least one target object indicated in the numerical data being equal to 1.
3-4. The estimation method according to 3-2., wherein
   the position data indicate an estimated mean position of the one or more target objects for the partial region with an estimated number of the at least one target object indicated in the numerical data being equal to or greater than 1, and
   the size data indicate an estimated size of a region including the one or more target objects for the partial region with an estimated number of the at least one target object indicated in the numerical data being equal to or greater than 1.
3-5. The estimation method according to any one of 3-1. to 3-4., wherein
   the output data include the likelihood data for each type of the target object.
4-1. A model generation method including, by one or more computers:
   acquiring training data in which a training image and ground truth data are associated with each other; and
   generating a model by performing machine learning using the training data, wherein
   input data of the model are an image, and
   output data of the model include:
      likelihood data indicating a likelihood of one or more target objects being included in each of a plurality of partial regions acquired by dividing the image; and
      numerical data indicating an estimated number of the at least one target object for the partial region estimated to include the one or more target objects out of the plurality of partial regions.
4-2. The model generation method according to 4-1., wherein
   the ground truth data include ground truth numerical data indicating a number of the at least one target object in each of a plurality of partial regions acquired by dividing the training image.
4-3. The model generation method according to 4-1. or 4-2., wherein,
   the one or more computers perform machine learning in such a way that the model outputs a number of the at least one target object in the partial region for the partial region in which the one or more target objects exist.
4-4. The model generation method according to 4-3., wherein
   the one or more computers perform machine learning in such a way that the model outputs a position and a size of the target object for the partial region with a number of the at least one target object being equal to 1.
4-5. The model generation method according to 4-3., wherein
   the one or more computers perform machine learning in such a way that the model outputs a mean position of the one or more target objects and a size of a region including the one or more target objects for the partial region with a number of the at least one target object being equal to or greater than 1.
5-1. A program causing a computer to function as an estimation apparatus, wherein
   the estimation apparatus includes:
      an acquisition unit that acquires an image; and
      an estimation unit that estimates a number of at least one target object included
in a target region being at least part of the acquired image by using a learned model,
   input data of the model are the image,
   output data of the model include:
      likelihood data indicating a likelihood of the one or more target objects being included in each of a plurality of partial regions acquired by dividing the image; and
      numerical data indicating an estimated number of the at least one target object for the partial region estimated to include the one or more target objects out of the plurality of partial regions, and
   the estimation unit estimates a number of the at least one target object included in the target region by using the likelihood data and the numerical data.
5-2. The program according to 5-1., wherein
   the output data further include position data indicating an estimated position of the target object for the partial region with an estimated number of the at least one target object indicated in the numerical data being equal to 1 or the partial region with the estimated number being equal to or greater than 1 and size data indicating an estimated size of the target object for the partial region with an estimated number of the at least one target object indicated in the numerical data being equal to 1 or the partial region with the estimated number being equal to or greater than 1, and
   the estimation unit estimates a position and a size of the target object by using the position data and the size data.
5-3. The program according to 5-2., wherein
   the position data indicate an estimated position of the target object only for the partial region with an estimated number of the at least one target object indicated in the numerical data being equal to 1, and
   the size data indicate an estimated size of the target object only for the partial region with an estimated number of the at least one target object indicated in the numerical data being equal to 1.
5-4. The program according to 5-2., wherein
   the position data indicate an estimated mean position of the one or more target objects for the partial region with an estimated number of the at least one target object indicated in the numerical data being equal to or greater than 1, and
   the size data indicate an estimated size of a region including the one or more target objects for the partial region with an estimated number of the at least one target object indicated in the numerical data being equal to or greater than 1.
5-5. The program according to any one of 5-1. to 5-4., wherein
   the output data include the likelihood data for each type of the target object.
6-1. A program causing a computer to function as a model generation apparatus, wherein
   the model generation apparatus includes:
      a training data acquisition unit that acquires training data in which a training image and ground truth data are associated with each other; and
      a generation unit that generates a model by performing machine learning using the training data,
   input data of the model are an image, and
   output data of the model include:
      likelihood data indicating a likelihood of one or more target objects being included in each of a plurality of partial regions acquired by dividing the image; and
      numerical data indicating an estimated number of the at least one target object for the partial region estimated to include the one or more target objects out of the plurality of partial regions.
6-2. The program according to 6-1., wherein
   the ground truth data include ground truth numerical data indicating a number of the at least one target object in each of a plurality of partial regions acquired by dividing the training image.
6-3. The program according to 6-1. or 6-2., wherein,
   the generation unit performs machine learning in such a way that the model outputs a number of the at least one target object in the partial region for the partial region in which the one or more target objects exist.
6-4. The program according to 6-3., wherein
   the generation unit performs machine learning in such a way that the model outputs a position and a size of the target object for the partial region with a number of the at least one target object being equal to 1.
6-5. The program according to 6-3., wherein
   the generation unit performs machine learning in such a way that the model outputs a mean position of the one or more target objects and a size of a region including the one or more target objects for the partial region with a number of the at least one target object being equal to or greater than 1.
7-1. A non-transitory computer-readable storage medium on which a program is recorded, the program causing a computer to function as an estimation apparatus, wherein
   the estimation apparatus includes:
      an acquisition unit that acquires an image; and
      an estimation unit that estimates a number of at least one target object included in a target region being at least part of the acquired image by using a learned model,
   input data of the model are the image,
   output data of the model include:
      likelihood data indicating a likelihood of the one or more target objects being included in each of a plurality of partial regions acquired by dividing the image; and
      numerical data indicating an estimated number of the at least one target object for the partial region estimated to include the one or more target objects out of the plurality of partial regions, and
   the estimation unit estimates a number of the at least one target object included in the target region by using the likelihood data and the numerical data.
7-2. The storage medium according to 7-1., wherein
   the output data further include position data indicating an estimated position of the target object for the partial region with an estimated number of the at least one target object indicated in the numerical data being equal to 1 or the partial region with the estimated number being equal to or greater than 1 and size data indicating an estimated size of the target object for the partial region with an estimated number of the at least one target object indicated in the numerical data being equal to 1 or the partial region with the estimated number being equal to or greater than 1, and
   the estimation unit estimates a position and a size of the target object by using the position data and the size data.
7-3. The storage medium according to 7-2., wherein
   the position data indicate an estimated position of the target object only for the partial region with an estimated number of the at least one target object indicated in the numerical data being equal to 1, and
   the size data indicate an estimated size of the target object only for the partial region with an estimated number of the at least one target object indicated in the numerical data being equal to 1.
7-4. The storage medium according to 7-2., wherein
   the position data indicate an estimated mean position of the one or more target objects for the partial region with an estimated number of the at least one target object indicated in the numerical data being equal to or greater than 1, and
   the size data indicate an estimated size of a region including the one or more target objects for the partial region with an estimated number of the at least one target object indicated in the numerical data being equal to or greater than 1.
7-5. The storage medium according to any one of 7-1. to 7-4., wherein
   the output data include the likelihood data for each type of the target object.
8-1. A non-transitory computer-readable storage medium on which a program is recorded, the program causing a computer to function as a model generation apparatus, wherein
   the model generation apparatus includes:
      a training data acquisition unit that acquires training data in which a training image and ground truth data are associated with each other; and
      a generation unit that generates a model by performing machine learning using the training data,
   input data of the model are an image, and
   output data of the model include:
      likelihood data indicating a likelihood of one or more target objects being included in each of a plurality of partial regions acquired by dividing the image; and
      numerical data indicating an estimated number of the at least one target object for the partial region estimated to include the one or more target objects out of the plurality of partial regions.
8-2. The storage medium according to 8-1., wherein
   the ground truth data include ground truth numerical data indicating a number of the at least one target object in each of a plurality of partial regions acquired by dividing the training image.
8-3. The storage medium according to 8-1. or 8-2., wherein,
   the generation unit performs machine learning in such a way that the model outputs a number of the at least one target object in the partial region for the partial region in which the one or more target objects exist.
8-4. The storage medium according to 8-3., wherein
   the generation unit performs machine learning in such a way that the model outputs a position and a size of the target object for the partial region with a number of the at least one target object being equal to 1.
8-5. The storage medium according to 8-3., wherein
   the generation unit performs machine learning in such a way that the model outputs a mean position of the one or more target objects and a size of a region including the one or more target objects for the partial region with a number of the at least one target object being equal to or greater than 1.

1. An estimation apparatus comprising:
at least one memory configured to store instructions; and
at least one processor configured to execute the instructions to perform operations comprising:
acquiring an image; and
estimating a number of at least one target object included in a target region being at least part of the acquired image by using a learned model, wherein
input data of the model are the image,
output data of the model include:
likelihood data indicating a likelihood of the one or more target objects being included in each of a plurality of partial regions acquired by dividing the image; and
numerical data indicating an estimated number of the at least one target object for the partial region estimated to include the one or more target objects out of the plurality of partial regions, and
estimation of a number of the at least one target object included in the target region is performed by using the likelihood data and the numerical data.

2. The estimation apparatus according to claim 1, wherein
the output data further include position data indicating an estimated position of the target object for the partial region with an estimated number of the at least one target object indicated in the numerical data being equal to 1 or the partial region with the estimated number being equal to or greater than 1 and size data indicating an estimated size of the target object for the partial region with an estimated number of the at least one target object indicated in the numerical data being equal to 1 or the partial region with the estimated number being equal to or greater than 1, and
the operations further comprise estimating a position and a size of the target object by using the position data and the size data.

3. The estimation apparatus according to claim 2, wherein
the position data indicate an estimated position of the target object only for the partial region with an estimated number of the at least one target object indicated in the numerical data being equal to 1, and
the size data indicate an estimated size of the target object only for the partial region with an estimated number of the at least one target object indicated in the numerical data being equal to 1.

4. The estimation apparatus according to claim 2, wherein
the position data indicate an estimated mean position of the one or more target objects for the partial region with an estimated number of the at least one target object indicated in the numerical data being equal to or greater than 1, and
the size data indicate an estimated size of a region including the one or more target objects for the partial region with an estimated number of the at least one target object indicated in the numerical data being equal to or greater than 1.

5. The estimation apparatus according to claim 1, wherein
the output data include the likelihood data for each type of the target object.

6. A model generation apparatus comprising:
at least one memory configured to store instructions; and
at least one processor configured to execute the instructions to perform operations comprising:
acquiring training data in which a training image and ground truth data are associated with each other; and
generating a model by performing machine learning using the training data, wherein input data of the model are an image, and
output data of the model include:
likelihood data indicating a likelihood of one or more target objects being included in each of a plurality of partial regions acquired by dividing the image; and
numerical data indicating an estimated number of the at least one target object for the partial region estimated to include the one or more target objects out of the plurality of partial regions.

7. The model generation apparatus according to claim 6, wherein
the ground truth data include ground truth numerical data indicating a number of the at least one target object in each of a plurality of partial regions acquired by dividing the training image.

8. The model generation apparatus according to claim 6, wherein,
the machine learning is performed in such a way that the model outputs a number of the at least one target object in the partial region for the partial region in which the one or more target objects exist.

9. The model generation apparatus according to claim 8, wherein
the machine learning is performed in such a way that the model outputs a position and a size of the target object for the partial region with a number of the at least one target object being equal to 1.

10. The model generation apparatus according to claim 8, wherein,
the machine learning is performed in such a way that the model outputs a mean position of the one or more target objects and a size of a region including the one or more target objects for the partial region with a number of the at least one target object being equal to or greater than 1.

11. An estimation method comprising, by one or more computers:
acquiring an image; and
estimating a number of at least one target object included in a target region being at least part of the acquired image by using a learned model, wherein
input data of the model are the image,
output data of the model include:
likelihood data indicating a likelihood of the one or more target objects being included in each of a plurality of partial regions acquired by dividing the image; and
numerical data indicating an estimated number of the at least one target object for the partial region estimated to include the one or more target objects out of the plurality of partial regions, and
estimation of a number of the at least one target object included in the target region is performed by using the likelihood data and the numerical data.
